(19) United States
(12) Patent Application Publication
(10) Pub. No.: US 2006/0237573 A1
(43) Pub. Date: Oct. 26, 2006

(54) Seat belt retractor with improved web sensor

(75) Inventors: Richard A. Boelstler, Lake Orion, MI (US); Rolando Negron, Macomb, MI (US); Carl M. Petersen III, Waterford, MI (US); Rudi Grzic, Sterling Heights, MI (US)

Correspondence Address: KEY SAFETY SYSTEMS, INC.;PATENT DEPARTMENT, 7000 NINETEEN MILE ROAD, STERLING HEIGHTS, MI, 48314, US

(73) Assignee: Key Safety Systems, Inc.

(21) Appl. No.: 11/388,676

(22) Filed: Mar. 24, 2006

Related U.S. Application Data
(60) Provisional application No. 60/673,903, filed on Apr. 22, 2005.

(51) Int. Cl. B60R 22/38

(52) U.S. Cl. 242/383.2

(57) ABSTRACT

A seat belt retractor (20) including a spool (100) and a web sensor configured to activate at a desired angular acceleration of the spool (web pullout), the web sensor (200) including an inertia wheel (202) rotatable relative to the spool, a sensor (210) having one or more lock teeth thereon, the sensor pawl (210) being rotationally supported relative to the spool, the web sensor (210) further including a torsion spring having a center coil and a first and second spring leg (206a) and (206b) respectively, the inertia wheel including a plurality of pins (308a-e), the placement of each pin configured to correspond to a set level of annular acceleration, the center coil centrally disposed on the inertia wheel and the first spring leg secured to the spool or pilot wheel and the second spring leg secured to a select one of the pins, the inner wheel configured to cause a relative rotation relative to the spool as the spool is rapidly moved, such relative rotation causing the movement of the sensor from a rest position to an activated position.

### BACKGROUND AND SUMMARY OF THE INVENTION

This application claims the benefit of U.S. Provisional Application 60/673,903, filed on Apr. 22, 2005. The disclosure of the above application is incorporated herein by reference.

The present invention relates generally to seat belt retractors and more particularly to a seat belt retractor having an improved web sensor.

It is an object of the present invention to provide an improved web sensor, one with improved dynamic performance and one that uses the same inertial wheel and spring to initiate seat belt lockup, but which can be activated at different preset levels within a range of desired dynamic performance levels specified by different end-users and governmental regulations.

Accordingly the invention comprises: a seat belt retractor including a spool and a web sensor configured to activate at one level of a plurality of desired webbing acceleration of the spool when the seat belt is withdrawn, the web sensor including an inertia wheel rotatable relative to the spool, a sensor pawl having one or more lock teeth thereon, the sensor pawl being rotationally supported relative to the spool, the web sensor further including a torsion spring having a center coil and first and second spring legs, the inertia wheel including a plurality of pins or posts, the placement of each pin configured to correspond to a set level of angular acceleration levels, the center coil centrally disposed on the inertia wheel and the first spring leg biased against a stop on the spool or pilot wheel and the second spring leg biased against one of the pins of the inertia mass, the inner wheel configured to cause a rotation relative to the spool as the spool is rapidly moved, such relative rotation causing the movement of the sensor pawl from a rest position to an activated position. The retractor further includes a lock ring rotationally positioned relative to the spool and selectively rotationally coupled to rotate with the spool upon movement of the sensor pawl.

Many other objects and purposes of the invention will be clear from the following detailed description of the drawings.

### BRIEF DESCRIPTION OF THE DRAWINGS

FIG. 1 is an exploded view of a seat belt retractor incorporating the present invention.

FIG. 2 is a partial cross-sectional view through section 2-2 of FIG. 1.

FIG. 3 is an end plan view of a spool showing a sensor pawl and thrust washer installed thereon.

FIG. 4 shows an inertia wheel in its rest position upon the spool.

FIG. 5 is a cross-sectional view through section 5-5 of FIG. 4.

FIG. 6 is a rear plan view of the inertia wheel.

FIG. 7 is a rear plan view of the lock ring.

FIG. 8 is a partial sectional view illustrating the components of the web sensor in a configuration that would initiate seat belt or retractor lockup.

FIGS. 9a, 9b, 9c and 9d show the front face of the inner disk with web sensor, a spring and various pins.

### DETAILED DESCRIPTION OF THE DRAWINGS

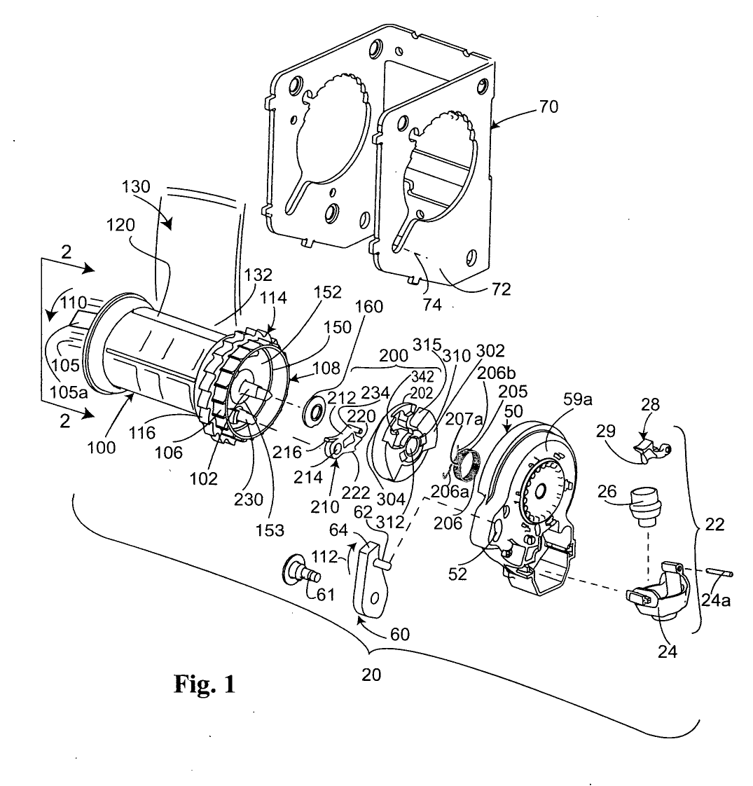

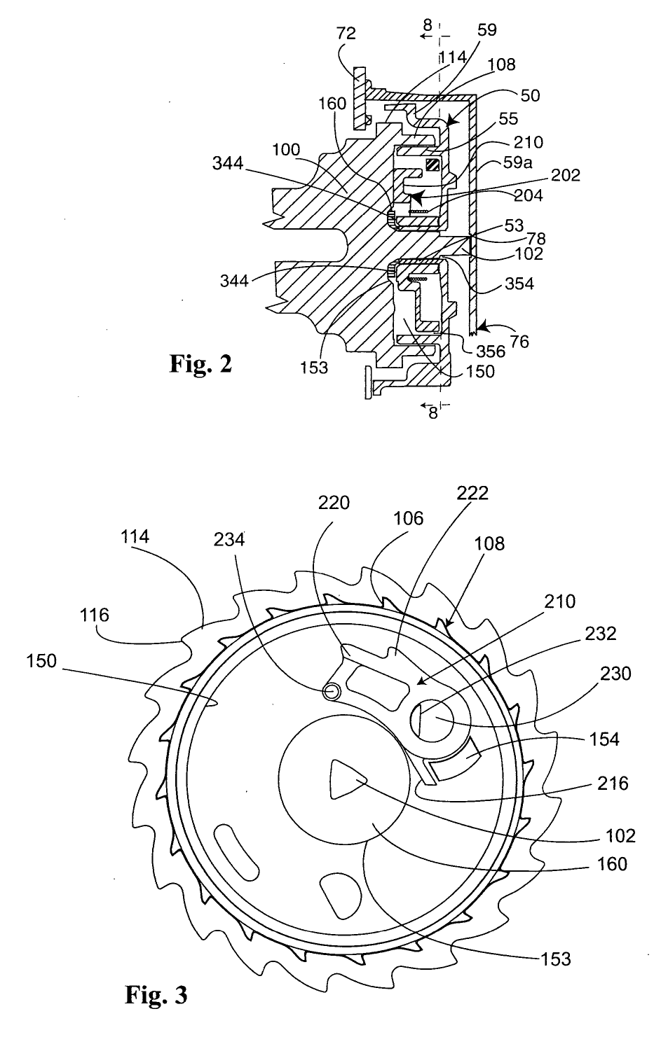

Reference is made to FIGS. 1 and 2, which illustrate various features of the present invention. FIG. 1 is an exploded view of the seat belt retractor 20 while FIG. 2 is a cross-sectional view taken through Section 2-2 of FIG. 1.

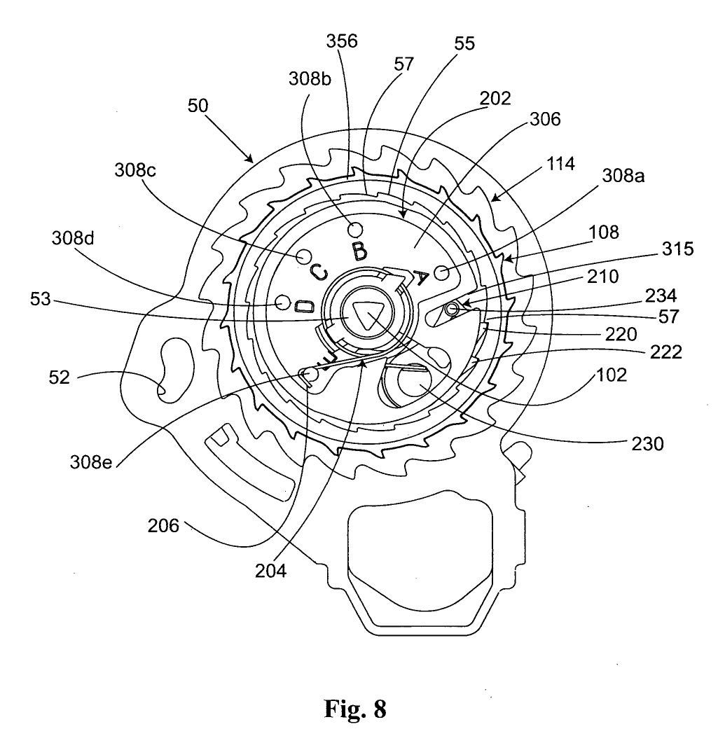

The seat belt retractor 20 includes many features found in known emergency locking retractors (ELRs). Retractor 20 includes a vehicle sensor 22, which comprises a housing 24, a movable mass 26 and a pivoted, movable sensor pawl 28 having at least one engagement tooth 29. The sensor pawl is pivoted relative to housing 24 about a pin 24a. The vehicle sensor 22 is fitted to or made part of a lock ring 50 of known design. The lock ring 50 is, during non-emergency conditions, rotationally isolated from a shaft 102 of a spool 100. In response to sensing a vehicle deceleration above a set level, mass 26 moves, causing sensor pawl 28 to enter into locking engagement with a tooth 106 of ratchet wheel 108, which is rotatable with spool 100. In the illustrated embodiment, ratchet wheel 108 is cast as part of the spool 100. In the illustrated embodiment of the invention, the spool is die cast zinc or aluminum or non-ferrous material. Lock ring 50 is piloted on the end of shaft 102 and is rotatable about the shaft. Engagement of sensor pawl 28 with one of the teeth 106 couples the lock ring 50 to the spool 100. Further rotation of the spool 100 in the direction of arrow 110, a belt unwinding direction, causes a like rotation of the lock ring 50 in a like direction. As described in conjunction with FIG. 8, the lock ring 50 includes a stub axle or hollow wall 53, which loosely envelops a shaft 102 and which serves as a bushing.

Lock ring 50 further includes an arcuate cam slot 52 and the retractor 20 further includes a lock pawl 60, of known design, that is pivoted upon a side 72 of retractor frame 70 along axis 74. The lock ring 50 is biased to a rest position relative to frame side 72 by a bias spring 51. The lock pawl 60 is pivotally secured to the frame 70 by a pin 61. The lock pawl 60 includes a pin 62, which functions as a cam follower. The pin 62 is slidingly received within slot 52. Rotation of the lock ring 50 in the direction of arrow 110 causes slot 52 to move relative to pin 62. Walls of slot 52 urge lock pawl 60, in the direction of arrow 112, into engagement with one or more teeth 116 of another ratchet wheel 114 of the spool. Upon engagement of the lock tooth 64 of lock pawl 60 into a tooth 116, spool 100 is locked against further rotation in the direction of arrow 110. Either of the ratchet wheels 108 or 114 can be an integral part of the spool or added separately to the spool.

As is known in the art, spool 100 is rotationally supported relative to a U-shaped, typically metal frame 70, in a known manner by bushings in the spool or formed within plastic parts attached to the frame. The spool 100 includes a center portion 120, which secures an end 132 of a length of seat belt webbing 130. The seat belt webbing (also referred to as a seat belt) is wound up about the center portion 120 of the seat belt retractor 20. The seat belt retractor includes a rewind spring 105 engageable with a spring arbor 105a located at an end of spool 100 opposite ratchet wheels 108 and 114 which, under normal non-emergency situations, rotates or rewinds the spool in a direction opposite to arrow 110 to retract and rewind the seat belt upon the spool.

The shaft 102, shown in FIGS. 1 and 2, can be made as an integral part of the spool, or alternately can be configured as an extending end of a torsion bar (not shown) or separate axle, which is located within a center bore or passage (not shown) of the spool 100. The shaft 102 is received in recess 78 (see FIG. 2) in a protective plastic cover 76 that is attached to the frame and covers the lock ring. The recess 78 acts as a bushing. Other known ways of supporting the shaft are within the scope of the invention. The center of the lock ring can also be rotationally supported on the hollow wall 53.

The seat belt retractor 20 further includes a web sensor generally identified as numeral 200. The web sensor 200 comprises an inertia wheel 202, a torsion spring 204 having legs 206a and 208a, each with an end 206 and 208, and a sensor pawl 210 having a body 212 with an opening or bore 214. The body further includes two engagement teeth 220 and 222. The body 212, near opening 214, includes an extending leg 216 that acts as a mechanical stop, limiting the inward rotation of the pawl 210. The body 212 further includes a pin 234, which acts as a cam follower. The web sensor pawl 210 is rotationally supported on a pin 230. Pin 230 has a flat side 232, and is provided as an integral formation of the spool 100. As can be seen from FIG. 1, ratchet wheel 108 forms a cup-shaped structure 150 at the end or side of spool 100. Pin 230 extends from a bottom 152 of this cup-shaped structure 150.

The retractor 20 further includes a thrust washer 160. The thrust washer 160 is received about the shaft 102 and fits in a narrow recess 153 in the bottom 152. The thrust washer 160 reduces sliding friction between the spool 100 and the inertia wheel 202. The placement of thrust washer 160 and the web sensor—sensor pawl 210 is also shown in FIG. 3. The bottom 152 includes another integrally formed projection 154 that cooperates with leg 216 of sensor pawl 210. As can be appreciated, the counterclockwise rotation, or inward motion, of pawl 210 in relation to FIG. 3, is stopped upon engagement of leg 216 with the projection 154

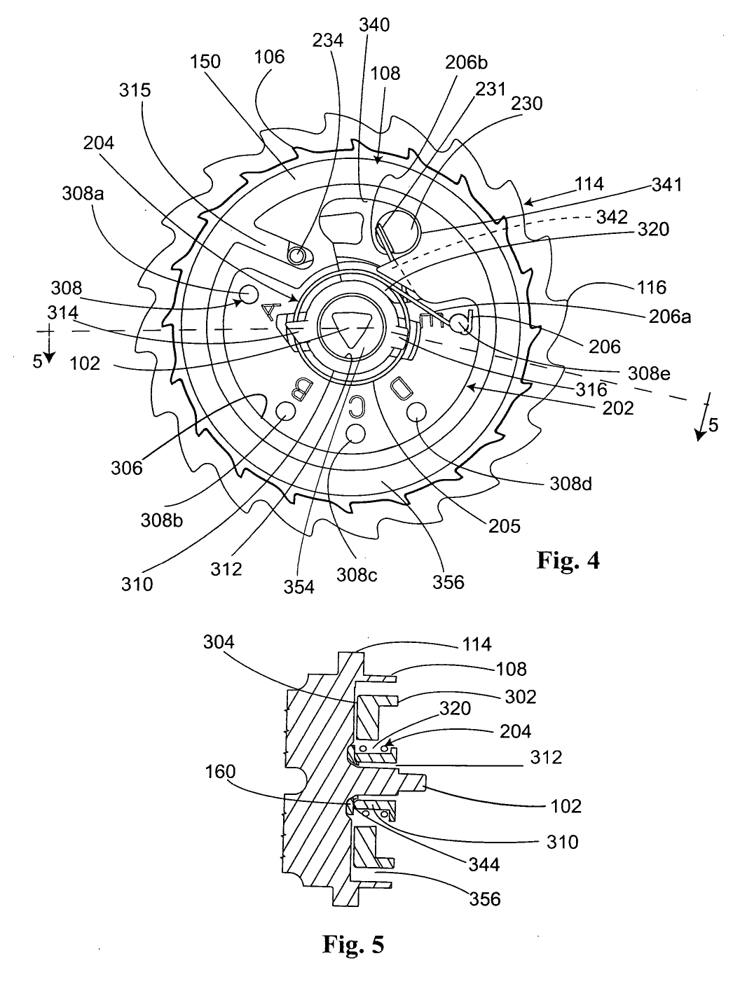

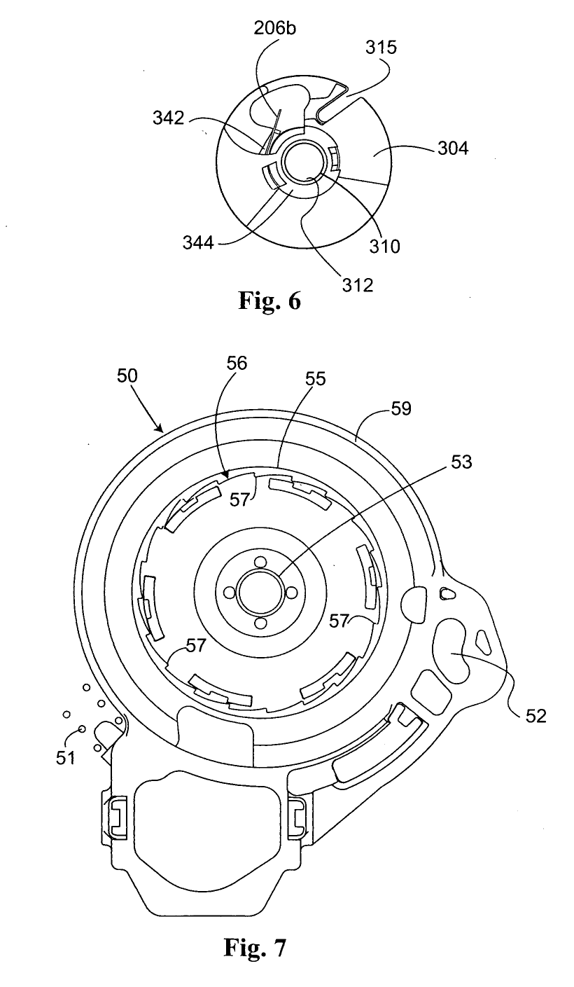

The inertia wheel 202 of the web sensor 200 is additionally shown in FIG. 4 in its assembled position upon the spool 100. The web sensor pawl is physically positioned below the inertia wheel in this figure. FIG. 4 shows a partially assembled seat belt retractor. FIG. 5 is a cross-sectional view through section 5-5 of FIG. 4 and FIG. 6 illustrates the inner or front surface (the opposite side) of the inertia wheel 202.

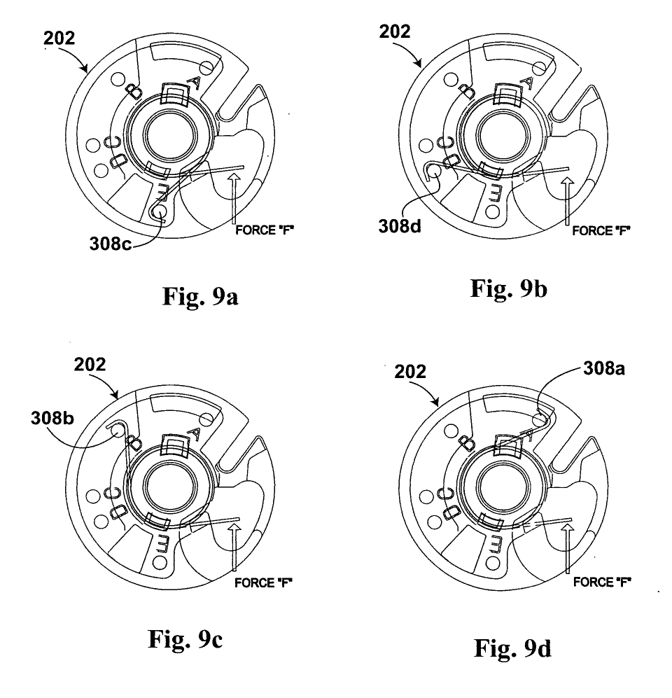

As mentioned, the inertia wheel 202 can be a zinc casting or a formed metal and includes a front or outer surface 302 and rear or inner surface 304 and a number of intermediate features. Both of the front and rear surfaces are stepped, that is they include a variety of different elevations or planes. The front surface 302 is formed with a cavity or depression 306. Within the cavity are a plurality of integrally formed pins 308 (308a-308e), see for example FIGS. 4 and 9a-9d. The position and purpose of the pins will be discussed below. As can be appreciated, each pin/post 308a-308e can be inserted in the inertia wheel. The wheel 202 includes a center, hollow axle 310. As can be seen in FIG. 5, a part of the shaft 102 extends through the hollow bore 312 of axle 310. The inertia wheel 202, i.e. axle 310, further includes a plurality of wings 314 and 316, which are located proximate the front surface 302. These wings 314 and 316 prevent the outward creep of the center or spiral coiled portion 205 of torsion spring 204, which is installed about the axle 310. An annulus 320 is located about the axle 310 and the center or spiral coiled portion 205 of the torsion spring is received therein. The spring leg, such as leg 206a, includes a bent end 206 (see FIG. 1), which envelops a portion of the selected pin.

In FIG. 4 the bent end 206 is positioned about pin 308e. The other leg 206b of the torsion spring 204 extends tangentially outward from the coiled portion 205 into an oblong opening 340 formed in the inertia wheel 202. Leg 206b has a bent portion 207a, which elevates the end of leg 206b from the corresponding end of the center coiled portion 205, enabling the end of leg 206b to be received within a notch or ledge 342 formed in the inertia wheel. A small annular projection or lip 344, see FIGS. 5 and 6, is formed at surface 304 to reduce the area in contact (contact area) with the thrust washer and reduce the rotational friction acting on the rear surface 304 of the inertia wheel 202.

Reference is again made to FIG. 4 and in particular the relationship between the inertia wheel 202 and shaft 102, as well as the inertia wheel 202 and the cup-shaped structure 150 formed by ratchet wheel 108. As can be seen, a first annular space 354 is identifiable between the hollow axle 310 and shaft 102 and a second annular space 356 is located between the outer circumference of the annular wheel 202 and the cup-shaped structure 150 (that is, the inner wall of ratchet wheel 108).

Reference is now made to FIG. 7, which is a plan view of the features formed on the rear face of the lock ring 50. As mentioned above, the lock ring 50, at its center, includes a hollow axle 53 (see FIG. 2), which is received about the end of axle 102 and functions as a bushing to stabilize the axial position of axle 102. Additionally the hollow axle 53 is positioned within the hollow annular space 354. This relationship can be seen in the cross-sectional view of FIG. 2. The lock ring further includes an extending cylindrical wall 55, the inner surface of which is formed as a ratchet wheel 56 having a plurality of teeth 57. On assembly, this cylindrical wall 55 is positioned within this space 356, with the ratchet teeth 57 facing the inertia wheel 202. On assembly, the ratchet wheel 108 is positioned about wall 55 and slightly spaced therefrom. The lock ring 50, at its outer edge, includes another cylindrical wall 59, and ratchet wheel 114 is positioned inside and spaced from wall 59. The lock ring 50 includes an outer wall or outer side face 59a (see FIG. 1) which envelops the web sensor 20 and which provides protection for the web sensor.

Reference is briefly made to FIG. 8. In FIG. 8 the outer wall or face portion 59a of the lock ring 50, that is above section line 9-9 of FIG. 2, has been removed for the purpose of illustration to more clearly show the inertia wheel and ratchet wheels.

The inertia wheel 202 further includes a cam slot 315 (see FIG. 4). With the inertia wheel 202 installed upon spool 100, the cam follower 234 of pawl 210 is received within slot 315. Additionally, leg 206b of the torsion spring 204 is positioned on the flat side face 231 of pin 230 facing slot 315. In this manner, the inertial wheel 202 is biased to rotate in a counterclockwise manner as seen in FIG. 4. The inertia wheel 202 will achieve a steady state position under the bias of spring 204 when end 341 of opening 340 bottoms against a generally opposite side of pin 230, as shown in FIG. 4. In this orientation, the cam follower or pin 234 of pawl 210 rests near the innermost depth of slot 315. Additionally, in this orientation, as a consequence of the cam follower 234 being in the above orientation, sensor pawl 210 is rotated away from ratchet teeth 57 of the ratchet wheel 55, so that sensor pawl teeth 222 are free from engagement with teeth 57.

During normal, non-emergency operation of the seat belt retractor 200, the torsion spring 204 will maintain the inertia wheel 202 generally in the condition as illustrated in FIG. 4, that is, with the sensor pawl 208 disengaged from the lock ring 50. During a vehicle crash, as the vehicle rapidly decelerates, the occupant who is wearing his or her seat belt will tend to move forwardly and thereby rapidly protract the shoulder belt or spool portion from the spool 100 (which extends directly from the retractor spool). The protraction of the shoulder belt causes the spool 100 to rapidly rotate in an unwinding direction, generally in the direction of arrow 110 of FIG. 1.

During the initial rapid movement of the spool in response to the rapid withdrawal of the seat belt, the inertia wheel 202 will tend to stay in its pre-crash orientation. Consequently, the rotation of the spool in concert with the tendency of the inertia wheel 202 to stay in place creates a relative displacement rotation between the spool and the inertia wheel. This relative rotation between the spool and the inertia wheel causes the cam follower 234 to move outwardly relative to slot 315 as the inner wheel rotates. This motion then causes the sensor pawl 210 to rotate about its pivot pin 230, urging the teeth 220 and 222 to engage and lock with corresponding teeth or tooth 57 of the lock ring. The above action thereby rotationally couples the lock ring 50 to the spool 100. Further rotation of the lock ring 50 moves a lock pawl 60 into locking engagement with the teeth 116 of the lock wheel or ratchet 114 formed on and movable with the spool 100. With lock pawl 60 lockingly engaged with the lock teeth 116, the retractor is once again locked from further rotation, preventing further pay-out of the seat belt.

Depending upon governmental or customer-supplied specifications, it may be desirable to have the web sensor activate when the web acceleration is between 0.3-0.70 g; then spring leg 206a is positioned on pin 308e, which positioning changes the bias force produced by spring 204, which acts upon inertia wheel 202. The selected bias force keeps the inertial wheel in place at a rest position until the acceleration equals or exceeds the desired level. If the desired lockup acceleration level is between 0.8 and 2.0 g, spring leg 206a is secured at pin or post 308d. If it is desired that the web sensor activate in the vicinity between 1.0 and 3.0 g, the spring is secured at pin 308c; if it is desired the web sensor activate in the vicinity of 3.0 g, the spring is secured at pin 308b; and if the maximum range is in the vicinity of 4.5 g, spring leg 206a is secured to pin 308a. As can be seen from the various figures, each pin (or post) 308a-308e is located at the radius from the center of inertia wheel 202; the spacing between adjacent posts 308a-308e varies.

Many changes and modifications in the above-described embodiment of the invention can, of course, be carried out without departing from the scope thereof. Accordingly, that scope is intended to be limited only by the scope of the appended claims.

1. A seat belt retractor (20) including a spool (100) and a web sensor configured to activate at one of a determinable plurality of desired angular acceleration of the spool (web pullout), the web sensor (200) including an spring loaded inertia wheel (202) rotatable relative to the spool, a sensor pawl (210) having one or more lock teeth thereon, the sensor pawl (210) being rotationally supported relative to the spool, the web sensor (210) further including a torsion spring having a center coil and a first and second spring leg (206a and 206b) respectively, each leg having an end (206, 208), the inertia wheel including a plurality of pins (308a-e), the center coil centrally disposed on the inertia wheel and the first spring leg secured to the spool and the second spring leg secured to a select one of the pins, the spring and pins configured to generate a predetermined bias force corresponding to a selected level of spool acceleration below which the inertia wheel remains in a rest position, the inner wheel configured to rotate relative to the spool as the spool is rapidly moved at a level of acceleration greater than or equal to the selected level of acceleration, such relative rotation causing the movement of the web sensor from a rest position to an activated position.

2. The retractor as defined in claim 1 further including a lock ring 50 rotationally positioned relative to the spool (100) in a belt unwinding direction upon selectively coupling of the lock ring with the spool, upon movement of the sensor pawl (210) to an activated position.

3. The retractor as defined in claim 1 wherein at least one of the spring legs (206a, 208a) includes a first section (207a) extending from the center coil (205), such first section off-set from an adjacent end of the center coil.

4. The retractor as defined in claim 3 wherein the inertia wheel includes a notch (342) under which the first section (207a) is received.

5. The retractor as defined in claim 1 wherein the spool includes a cup-like formation (150) into which is received the inertia wheel and wherein the inertia wheel includes a friction reducing formation (344) to reduce friction between the cup-like formation and the inertia wheel.

6. The retractor as defined in claim 5 wherein the sensor pawl (210) includes an extending leg (216) which cooperates with an upraised formation (154) on the cup-like spool formation, the leg (216) configured to contact the upraised formation to limit the rotation of the sensor pawl.

7. The retractor as defined in claim 1 wherein the inertia wheel includes 5 pins (308a-308e) with a space between each adjacent pin, wherein the spacing between a third and fourth pins is less than the spacing between the third and a second pin, which is less than the spacing between the second a first pin, which is less than the spacing between the fourth pin and a fifth pin.

8. A seat belt retractor (20) including a spool (100) and a web sensor configured to activate at a desired angular acceleration of the spool (web pullout), the web sensor (200) including an inertia wheel (202) rotatable relative to the spool, a sensor pawl (210) having one or more lock teeth thereon, the sensor pawl (210) being rotationally supported relative to the spool, the web sensor (210) further including a torsion spring having a center coil and a first and second spring leg (206a and 206b) respectively, the inertia wheel including a plurality of pins (308a-e), the placement of each pin configured to correspond to a set level of annular acceleration, the center coil centrally disposed on the inertia wheel and the first spring leg secured to the spool or pilot wheel and the second spring leg secured to a select one of the pins, the inner wheel configured to cause a relative rotation relative to the spool as the spool is rapidly moved, such relative rotation causing the movement of the sensor from a rest position to an activated position.

9. The retractor as defined in claim 1 further including a lock ring rotationally positioned relative to the spool and selectively rotationally coupled to rotate with the spool upon movement of the sensor pawl.
